(19) United States
(12) Patent Application Publication
(10) Pub. No.: US 2018/0338284 A1
(43) Pub. Date: Nov. 22, 2018

(54) RESOURCE UTILIZATION FOR REDUCED USER EQUIPMENT POWER CONSUMPTION

(71) Applicant: QUALCOMM Incorporated, San Diego, CA (US)

(72) Inventors: Ankit MAHESHWARI, Hyderabad (IN); Atul SONI, Hyderabad (IN); Shruti AGRAWAL, Hyderabad (IN); Rimal PATEL, Hyderabad (IN)

(21) Appl. No.: 15/673,268

(22) Filed: Aug. 9, 2017

Related U.S. Application Data
(60) Provisional application No. 62/508,206, filed on May 18, 2017.

(51) Int. Cl. H04W 52/02; H04W 72/04

(52) U.S. Cl. CPC H04W 52/0225; H04W 48/12; H04W 52/0219; H04W 72/0493

(57) ABSTRACT

A user equipment (UE) determines availability of one or more of the radio frequency (RF) resources (e.g., shared power tracking mode devices) and dynamically assigns (during simultaneous active operation or transmission by the two or more transmit chains) one or more RF resources to selected one or more active transmit chains in the user equipment. In one instance, the UE selectively assigns the shared power tracking mode device(s) to the active transmit chain(s) based on the determined availability.

### CROSS-REFERENCE TO RELATED APPLICATION

The present application claims the benefit of U.S. Provisional Patent Application No. 62/508,206, filed on May 18, 2017, and titled “RESOURCE UTILIZATION FOR REDUCED USER EQUIPMENT POWER CONSUMPTION,” the disclosure of which is expressly incorporated by reference herein in its entirety.

### TECHNICAL FIELD

The present disclosure generally relates to power amplifiers. More specifically, the present disclosure relates to determining a power tracking mode to be enabled for one or more transmit paths of a user equipment to improve radio frequency (RF) power consumption.

### BACKGROUND

Wireless communication devices include a power amplifier (PA) to provide high transmit power for an output RF signal. The wireless communication devices include the power amplifier to amplify an input RF signal to a desired level for transmission, which may depend on how far the user is away from a base station. Next generation wireless systems use a wideband technology that allows for simultaneously transmitting multiple transmit signals, corresponding to different baseband signals, to one or more base stations over multiple channels. In some mobile communication devices, this specifies transmitting the multiple transmit signals using a single power amplifier.

Because power amplification consumes power, techniques to improve the efficiency of power amplifiers may be implemented in mobile communication devices in order to prolong operation on a battery charge. Such techniques may include adjusting the power supplied to the power amplifier so that the applied power tracks the amount of power in the transmit signal. Adjusting the applied power based on the transmit signal is referred to generally as “envelope tracking” and there are different forms or modes of envelope tracking that can be implemented. Power supply envelope tracking circuitry, however, increases the cost of a mobile device. Thus, some lower cost mobile devices do not have this feature available for each transmission channel.

### SUMMARY

In an aspect of the present disclosure, a method of assigning shared resources to one or more active transmit chains of a user equipment (UE), in which the user equipment includes fewer shared power tracking mode devices than active transmit chains, is presented. The method includes determining availability of one or more shared power tracking mode devices of the user equipment. The method also includes selectively assigning the one or more shared power tracking mode devices to the one or more active transmit chains based on the determined availability.

Another aspect discloses an apparatus for assigning shared resources to one or more active transmit chains of a user equipment (UE), in which the user equipment includes fewer shared power tracking mode devices than active transmit chains. The apparatus includes a memory and one or more processors coupled to the memory. The processor(s) is configured to determine availability of one or more shared power tracking mode devices of the user equipment. The processor(s) is also configured to selectively assign the one or more shared power tracking mode devices to the one or more active transmit chains based on the determined availability.

In yet another aspect of the present disclosure, an apparatus for assigning shared resources to one or more active transmit chains of a user equipment (UE), in which the user equipment includes fewer shared power tracking mode devices than active transmit chains, is presented. The apparatus includes means for determining availability of one or more shared power tracking mode device of the user equipment. The apparatus also includes means for selectively assigning the one or more shared power tracking mode devices to the one or more active transmit chains based on the determined availability.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 shows a block diagram of a wireless communication device.

FIG. 2 shows a block diagram of a conventional power amplifier (PA) module or power amplification device.

FIG. 3 illustrates a power tracking mechanism for a power amplifier (PA).

FIG. 4 is a block diagram illustrating an example configuration of components associated with controlling operation modes of a power amplifier on one or more radio frequency (RF) resources.

FIG. 5 is an illustration of digital sample rotator mechanism to achieve placement of a transmit path signal and an envelope signal adjacent to each other according to aspects of the present disclosure.

FIG. 6 illustrates a digital to analog converter (DAC) sharing mechanism according to aspects of the present disclosure.

FIG. 7 is a process flow diagram illustrating a method of assigning shared resources to one or more active transmit chains of a user equipment (UE) according to aspects of the present disclosure.

FIG. 8 is a block diagram showing an exemplary wireless communication system in which a configuration of the disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

A wireless communication device, such as a user equipment (UE), may include transmit chains that are composed of multiple radio frequency (RF) transmitters, multiple power amplifiers, multiple antennas, and one or more front end (FE) devices through which signals are transmitted from the UE. The transmit chains of the UE, however, may include a class of power amplifiers that are designed for meeting a power level specified for a current device generation.

Various aspects of the present disclosure improve performance of a multi-channel wireless communication device (e.g., multi-subscriber identification module (SIM) multi-active (MSMA) wireless communication device or a carrier aggregation enabled wireless communication device) engaged in simultaneous communications by enabling a first power-saving mode or power tracking mode, in some multi-channel scenarios. The wireless communication device may be configured to use two or more power tracking modes including envelope tracking (ET) mode, enhanced power tracking (EPT) mode, average power tracking (APT) mode, and bypass mode (or no power tracking mode). The envelope tracking mode, may provide the most reduction in power consumption by the power amplifier (e.g., may cause the power amplifier to consume the least current). The enhanced power tracking mode and the average power tracking mode provide less reduction in power consumption by the power amplifier than the envelope tracking mode. The average power tracking mode may provide less reduction in power consumption by the power amplifier than the enhanced power tracking mode. Additionally, a selection of a no power-saving mode or a bypass mode may provide little or no reduction in the power consumed by the power amplifier.

While some wireless communication devices that are capable of operating in a first power tracking mode (e.g., envelope tracking mode) include additional circuitry or RF resources (e.g., an additional digital to analog converter (DAC)) for this purpose as part of an envelope tracking module, such additional circuitry increases the cost and power specifications of the wireless communication device. The additional RF resources (e.g., DAC) ensure that the power amplifier bias is closely tracking an envelope of the transmitted signal. For example, to implement the envelope tracking mode, an additional DAC may be specified in order to ensure that the power amplifier only receives the voltage, and thus the power, specified to deliver the transmit RF signal in a linear fashion. Such additional components may be separately provided on the wireless communication device.

To avoid the cost of the additional RF resources, some carrier aggregation or MSMA wireless communication devices opportunistically use an RF resource associated with an inactive or idle SIM to support the first power tracking mode for an active SIM. For example, in a dual SIM dual active (DSDA) device transmitting a signal using a first RF resource, the first power tracking mode may be enabled by using a DAC associated with a first transmit chain for a transmit RF signal while the DAC associated with a second transmit chain may be used for an envelope of the transmit RF signal. However, if both RF resources of the first transmit chain and the second transmit chain are used or active at the same time, such as for simultaneous communications on the SIMs, the RF resource (e.g., DAC) associated with the second transmit chain is unavailable for the opportunistic first power tracking mode. As a result, the power tracking mode of the power amplifier of the first transmit chain falls back to a less power efficient mode (e.g., EPT or APT).

Aspects of the present disclosure are directed to assigning shared RF resources to one or more active transmit chains of a user equipment based on availability of the shared RF resources. The shared resources may include devices (hardware devices) specified to implement the various power tracking modes. For example, the shared devices may include shared power tracking mode devices and DACs to facilitate the power tracking mode. Examples of the shared power tracking mode devices include a switched mode power supply (SMPS) switcher and an envelope tracking power supply. The shared tracking mode devices may be shared between multiple active transmit chains of the user equipment because of the limited availability of the shared RF resources to support each of the multiple transmit chains. Moreover, some UEs may not be equipped with the shared RF resources for each possible transmit channel. To facilitate the sharing of the RF resources, aspects of the present disclosure are directed to mechanisms and criteria to determine and select a transmit path or chain on which the different modes, such as power tracking (e.g., envelope tracking) mode, can be enabled to achieve improved performance and efficiency of the user equipment.

In one aspect of the disclosure, the UE determines availability of one or more of the RF resources (e.g., shared power tracking mode devices) and dynamically assigns (during simultaneous active operation or transmission by the two or more transmit chains) one or more RF resources to selected one or more active transmit chains in the user equipment. For example, a processor (e.g., a modem processor) in the user equipment determinates availability of the shared tracking mode devices and dynamically assigns the one or more power tracking mode devices to a transmit chain on which a power tracking or saving mode (e.g., APT) can be enabled.

The UE may be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

The user equipment may also determine a number M of the multiple active transmit chains and may then determine a number N of the multiple shared power tracking mode devices. When the number M of the multiple active transmit chains is determined to be more than the number N of the multiple shared power tracking mode devices, the UE confirms that the RF resources for the active transmit chains are limited. In one exemplary UE, each transmit chain may be provided with one or more power tracking mode devices. Similarly, the UE may determine that a number O of the shared DACs is smaller than the number M of the multiple active transmit chains. These determinations cause the UE to share the one or more power tracking mode devices and the one or more DACs between the multiple active transmit chains, according to aspects of the present disclosure, to improve efficiency and performance of the UE.

In some aspects of the present disclosure, the UE determines the power tracking mode to be allocated to the one or more active transmit chains based on one or more previously stored parameters of the active transmit chain(s). The previously stored parameters may include a cumulative current consumption of the active transmit chains operating under different conditions. In one aspect of the disclosure, a look up table (LUT) may store cumulative current consumption by all the active transmit chain(s) operating in different conditions. For example, the different conditions may include one or more of the power tracking modes (e.g., ET, APT, EPT, etc.) and operating frequency bands of the active transmit chains. The parameters may be arranged in accordance with the LUT and stored in a memory of the UE. The parameters may be previously measured or allocated based on the specification of the devices (e.g., power amplifier (PA)) of each transmit chain.

For example, the LUT can be constructed for all supported long term evolution (LTE) frequency bands, arranged in order of current consumption. These LUTs can be created by data provided by device manufacturers using existing data sheets of RF transceivers and PAs that mention current consumption versus frequency. The relevant data for the LUT can also be measured as a part of a device test procedure and stored during a factory process.

In one aspect of the present disclosure, a current consumption metric (rather than transmit power) is one of the criteria to determine and select a transmit path or chain on which the different power tracking modes can be enabled to achieve improved performance and efficiency of the UE. In some designs, depending on the frequency band, there can be scenarios where current consumption for frequency band A at 20 dBm may be higher than for frequency band B at 22 dBm even with the same power tracking mode. The current consumption metric also takes into account the frequency band and the power tracking mode in use to improve battery efficiency.

The stored parameters may also include a peak to average ratio (PAR) or a peak to average power ratio (PAPR) of a signal transmitted on each of the active transmit chains operating under different conditions. These criteria may help decide a fallback mode of operation on respective uplink carriers. PAR of the transmit RF signal is not constant and varies considerably based on the number of control and physical channels. PAR may also vary significantly based on a modulation technique being used for uplink signal transmission. For example, for a transmit RF signal with high PAR variations, the power amplifier bias applied in no power tracking mode or average power tracking mode may be highly inefficient (because the bias applied is specified to be high enough to ensure linearity for the worst signal variation).

With the inputs and criteria available, a UE determines the transmit paths and the corresponding power tracking modes to be applied. In some aspects, the power tracking solutions may be prioritized and stored in a memory of the UE. For example, the power tracking modes can be listed in an order of decreasing priority (based on, for example, original equipment manufacturer (OEM) designs). One order of listing includes envelope tracking mode, then enhanced power tracking mode, followed by average power tracking mode, and then “no” power tracking mode.

Similarly, based on the current consumption and PAR variations metrics, the current active transmit chains may be ordered according to priority. For example, a first consideration may be to arrange the uplink paths in order of decreasing current consumption (C1, C2, and C3) where current consumption C1>C2>>C3 for a three uplink active case. In one aspect of the disclosure, when a current consumption delta between the top two carriers is comparable (say within a pre-determined threshold), PAR variations are the second consideration to distinguish the carriers and select where a power tracking mode (e.g., envelope tracking mode) is to be applied. Aspects of the present disclosure may be applied to scenarios with only one envelope tracking digital to analog converter (DAC) available. The aspects may be similarly extended to cases where there are more uplink carriers, more envelope tracking DACs, or more power tracking mode devices.

A power tracking mode device may be dynamically assigned to an active transmit chain based on the power tracking mode allocated to the active transmit chain for transmission. For example, an additional power tracking mode device (e.g., switched mode power supply (SMPS) switcher) may be assigned to the power amplifier of the active transmit chain when the active transmit chain is allocated an average power tracking mode or an enhanced power tracking mode to regulate the power amplifier bias. Further, an additional DAC may be assigned to a power amplifier of the active transmit chain when the active transmit chain is allocated an envelope tracking mode to ensure that power amplifier bias is tracking an envelope of the transmit RF signal.

One example includes three uplink carriers (M=3) corresponding to three active transmit paths or chains, two power tracking mode devices (N=2), and one envelope tracking DAC available (O=1). In this example, current consumption of carrier 1 is comparable to current consumption of carrier 2 and significantly greater than the current consumption of carrier 3. A modulation and coding scheme (MCS) or modulation scheme of carrier 1 is higher than that of carrier 2 (say 256 QAM versus 16 QAM) (this may indicate a higher PAR for carrier 1). According to aspects of the present disclosure, carrier 1 may have envelope tracking (ET) mode enabled (using one ET DAC and one power tracking mode device). Carrier 2 may have APT or EPT enabled (using one power tracking mode device) and carrier 3 may be operating in the default bypass mode.

The present disclosure may be beneficial for a two uplink active scenario as well as for scenarios where current consumption cannot be a deciding factor for enabling either APT or ET (based on hardware design). For example, current consumption may be comparable for the two uplink paths while PAR is different for both of the carriers (say higher for carrier 2). Enabling APT or ET for carrier 2 may result in improved UE battery performance as compared to default enabling of APT or ET on the first uplink transmit path.

In another aspect of the disclosure, a first transmit RF signal of a first active transmit chain is combined with an envelope of a second transmit RF signal of a second active transmit chain using digital sample rotation. The combined signals may then be routed to a same shared DAC. The envelope of a second transmit signal may then be filtered after the DAC, using an envelope filter, from the combined signals and used for power tracking. Using the proposed digital sample rotation assisted DAC sharing mechanism, envelope tracking can be enabled simultaneously with an active second transmit path.

The power tracking mode implemented according to aspects of the disclosure improves efficiency of the power amplifier during transmission on the wireless communication device by varying or controlling a voltage level of the power supply of the power amplifier in relation to an envelope of the transmit RF signal. Thus, when the power level of the transmit RF signal increases or decreases, there is a corresponding increase or decrease in the voltage supplied to the power amplifier.

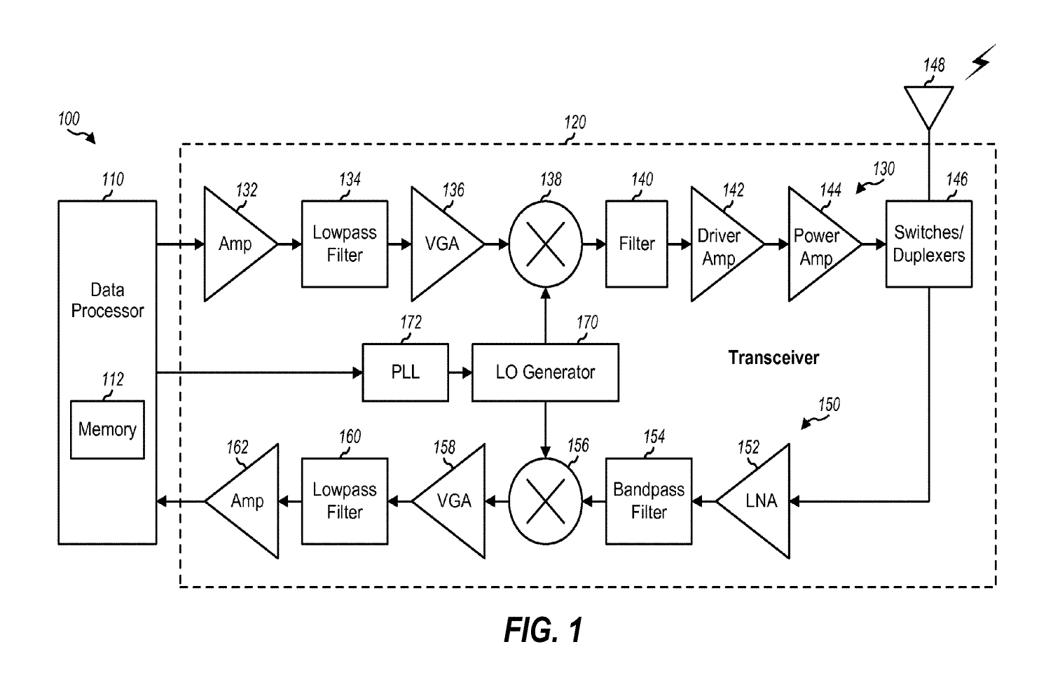

FIG. 1 shows a block diagram of an exemplary design of a wireless communication device or wireless communication device 100 that may include dynamic resource utilization. In this exemplary design, the wireless communication device 100 includes a data processor 110 and a transceiver 120. The transceiver 120 includes a transmitter 130 and a receiver 150 that support bi-directional wireless communication. In general, the wireless communication device 100 may include any number of transmitters and any number of receivers for any number of communication systems and any number of frequency bands.

In the transmit path, the data processor 110 processes data to be transmitted and provides an analog output signal to the transmitter 130. Within the transmitter 130, the analog output signal is amplified by an amplifier (Amp) 132, filtered by a low pass filter 134 to remove images caused by digital-to-analog conversion, amplified by a VGA 136, and upconverted from baseband to radio frequency (RF) by a mixer 138. The upconverted signal is filtered by a filter 140, further amplified by a driver amplifier 142 and a power amplifier 144, routed through switches/duplexers 146, and transmitted via an antenna 148.

In the receive path, the antenna 148 receives signals from base stations and/or other transmitter stations and provides a received signal, which is routed through the switches/duplexers 146 and provided to the receiver 150. Within the receiver 150, the received signal is amplified by a low noise amplifier (LNA) 152, filtered by a bandpass filter 154, and downconverted from RF to baseband by a mixer 156. The downconverted signal is amplified by a VGA 158, filtered by a low pass filter 160, and amplified by an amplifier 162 to obtain an analog input signal, which is provided to the data processor 110.

FIG. 1 shows the transmitter 130 and the receiver 150 implementing a direct-conversion architecture, which frequency converts a signal between RF and baseband in one stage. The transmitter 130 and/or the receiver 150 may also implement a super-heterodyne architecture, which frequency converts a signal between RF and baseband in multiple stages. A local oscillator (LO) generator 170 generates and provides transmit and receive LO signals to the mixers 138 and 156, respectively. A phase locked loop (PLL) 172 receives control information from the data processor 110 and provides control signals to the LO generator 170 to generate the transmit and receive LO signals at the proper frequencies.

FIG. 1 shows an exemplary transceiver design. In general, the conditioning of the signals in the transmitter 130 and the receiver 150 may be performed by one or more stages of amplifier, filter, mixer, etc. These circuits may be arranged differently from the configuration shown in FIG. 1. Furthermore, other circuits not shown in FIG. 1 may also be used in the transmitter and the receiver. For example, matching circuits may be used to match various active circuits in FIG. 1. Some circuits in FIG. 1 may also be omitted. The transceiver 120 may be implemented on one or more analog integrated circuits (ICs), radio frequency ICs (RFICs), mixed-signal ICs, etc. For example, the amplifier 132 through the power amplifier 144 in the transmitter 130 may be implemented on an RFIC. The driver amplifier 142 and the power amplifier 144 may also be implemented on another IC external to the RFIC.

The data processor 110 may perform various functions for the wireless communication device 100, e.g., processing for transmitted and received data. A memory 112 may store program codes and data for the data processor 110. The data processor 110 may be implemented on one or more application specific integrated circuits (ASICs) and/or other ICs.

As shown in FIG. 1, a transmitter and a receiver may include various amplifiers. Each amplifier at RF may have input impedance matching and output impedance matching, which are not shown in FIG. 1 for simplicity.

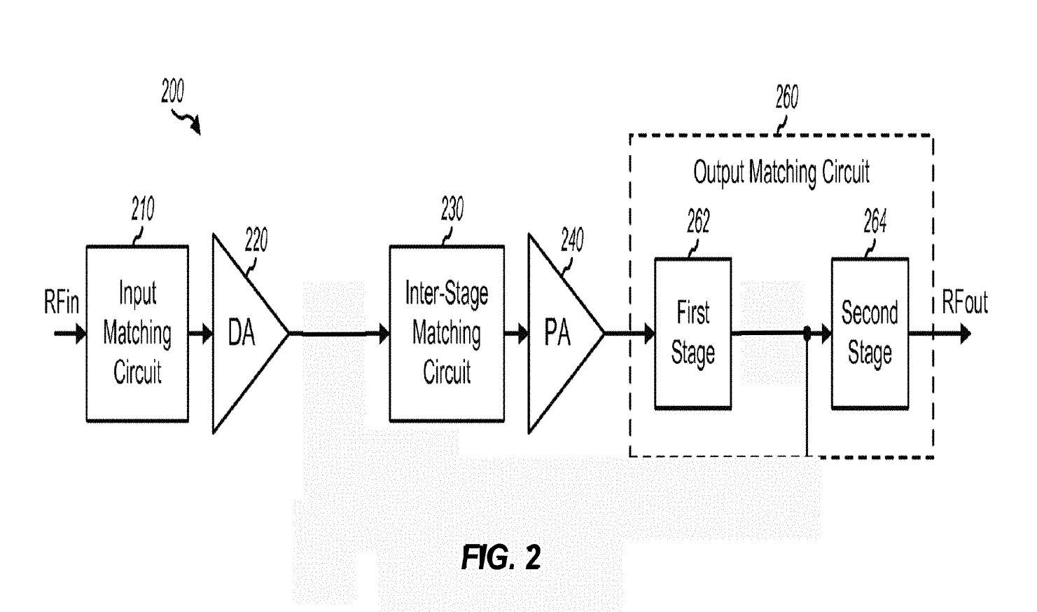

FIG. 2 shows a block diagram of a conventional power amplifier (PA) module or power amplification device 200. A conventional two-stage power amplifier of the power amplification device 200 includes a driver amplifier (DA) 220 and power amplifier core or power amplifier 240. The driver amplifier may be an open drain driver amplifier. The power amplification device 200 may be used for the driver amplifier 142 and the power amplifier 144 in FIG. 1. Within the power amplification device 200, an input matching circuit 210 receives an input radio frequency signal (RFin) and has its output coupled to the input of the driver amplifier (DA) 220. The DA 220 is coupled to an inter-stage matching circuit 230. A power amplifier 240 has its input coupled to the output of the inter-stage matching circuit 230 and its output coupled to the input of an output matching circuit 260. The output matching circuit 260 includes a first stage 262, and a second stage 264 coupled in series. The first stage 262 is coupled to the input of the second stage 264. The output matching circuit 260 provides an output RF signal (RFout).

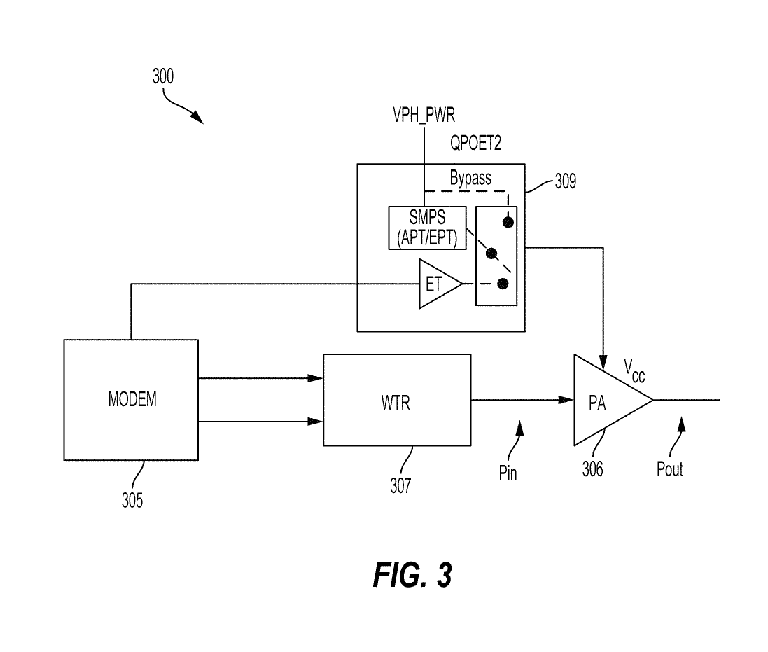

FIG. 3 illustrates a power tracking mechanism 300 for a power amplifier (PA) 306. The power tracking mechanism 300 may be implemented in a transmit chain and includes a modem 305, transmit devices 307 (e.g., driver amplifier (s), filter(s), mixer(s), digital to analog (DAC) converter(s), etc.) and a power tracking mode device 309.

A radio frequency (RF) PA (e.g., PA 306) is one of the major sources of current consumption in a wireless communication device design. There are algorithms to optimize the PA current consumption while still maintaining desired linearity and efficiency. Mobile designs may implement one or more (in combination) techniques using the power tracking mode device 309. The techniques include an envelope tracking (ET) mode, enhanced power tracking (EPT) mode and average power tracking (APT). In APT mode, the PA 306 operates in a linear mode of operation with bias changing as a function of transmit power. In EPT/ET modes, the PA 306 is operated at a sub-optimal bias (in compressed mode) and the non-linearity is corrected by applying digital pre-distortion (DPD).

The power tracking modes, however, specify additional hardware or increased cost (e.g., cost associated with bill of materials). For example, an additional power tracking mode device (e.g., switch mode power supply (SMPS) switcher) is specified to regulate the PA bias in the average and enhanced power tracking modes. For a user equipment (UE) to operate in envelope tracking mode, an additional digital to analog converter (DAC) is specified along with the power tracking mode device (e.g., envelope tracking power supply) to ensure that the PA bias is closely tracking an envelope of a transmitted signal. If no power tracking mode device or envelope tracking DAC is available, the fallback implementation is to have the PA directly driven by a battery (Vbatt). However, it is well established that current consumption for a transmit chain can be improved using envelope tracking in accordance with one of the modes instead of the fallback implementation.

Power tracking may be applied to dual subscriber identity module (SIM) dual active (DSDA) capable devices where two transmit paths are active at a same time. This implies that an efficient hardware design may have two power tracking mode devices and two (envelope tracking) DACs installed for PA current efficiency. With newer 3GPP releases, LTE-Advanced supports carrier aggregation of two or more downlink and/or uplink (UL) carriers active at a same time for higher throughput specifications. For example, the UE may be specified to operate all the transmit paths in envelope tracking mode to ensure maximum battery efficiency.

For this specification, two DACs (one for the transmit path and one for the envelope tracking path) may be specified for each uplink path. Moreover, more than two uplink carriers for a carrier aggregation system can be considered in hardware design specifications. This results in higher bill of materials (BOM) and other considerations when there are more uplink carriers that can be simultaneously active (three of four uplink carriers. However, due to the hardware design and cost considerations, it is unrealistic to assume that original equipment manufacturers (OEMs) are planning to add hardware changes to support envelope tracking on all active transmit chains. Additionally, given that a power tracking mode device is specified, even for APT mode, the majority of OEMs may not include power tracking devices for all transmit paths.

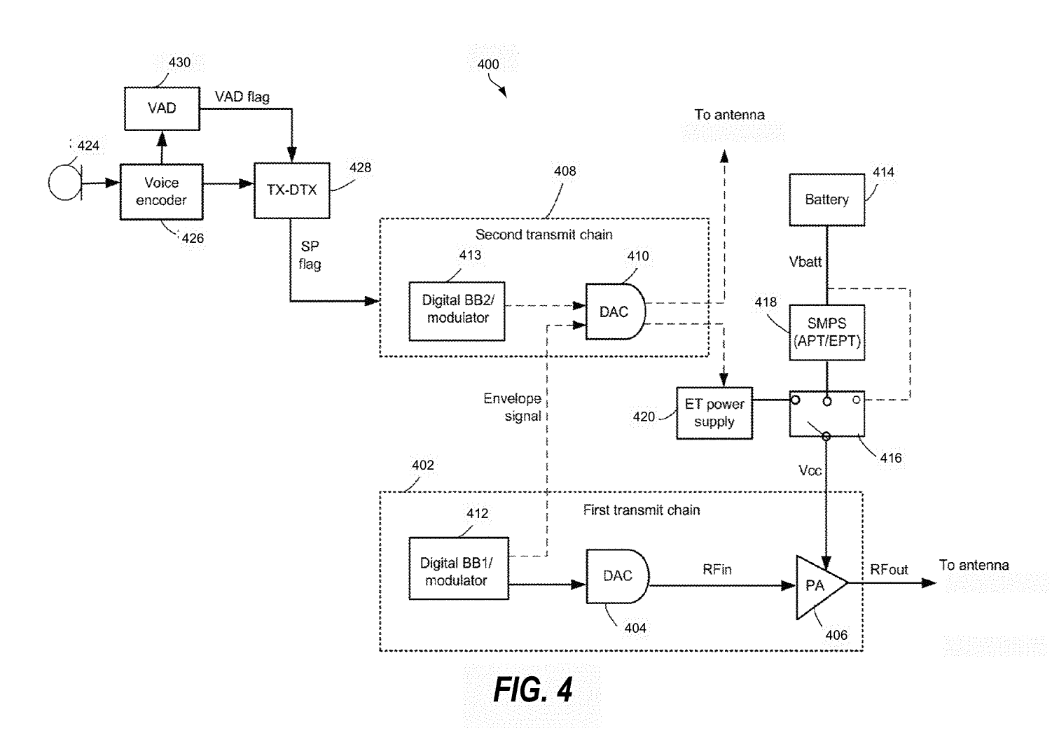

Accordingly, it is desirable to determine when power tracking modes are enabled and for which transmit path is currently active. Some opportunistic envelope tracking techniques are implemented by borrowing a DAC from a second transmit chain during inactive or silent periods, as shown in FIG. 4. However, these opportunistic envelope tracking techniques are limited or undesirable because envelope tracking is not always “on” and the envelope tracking depends on silent periods of the second active connection or active transmit chain. Moreover, these opportunistic envelope tracking techniques are limited to a particular radio access technology. For example, the implementation is undesirable for active communications of a first radio access technology X (e.g., long term evolution (LTE)) and a different radio access technology Y (e.g., global system for mobile communications (GSM)).

FIG. 4 illustrates a configuration 400 of transmission elements that may interact in a multi-SIM multi-active wireless communication device or a carrier aggregation enabled wireless communication device to enable use of different power tracking modes to control power amplification. In particular, the configuration 400 may enable the wireless communication device to operate in a bypass mode and a different power-saving mode (e.g., APT or EPT).

In various aspects, communication data associated with a first transmit channel (e.g., a first uplink component carrier) may be processed for transmission through a corresponding first transmit chain 402. The first transmit chain 402 may include any one or more components performing functions to route communication data associated with the first uplink carrier for transmission through a corresponding baseband-RF resource chain. In some aspects, the first transmit chain 402 may include functional components of a baseband modem processor(s) (BB1) and RF front end components of an RF resource to condition signals for transmission. Such RF front end components may include, for example, a digital-to-analog converter (DAC) 404, a power amplifier (PA) 406, as well as filters, mixers, and other components that are not shown, the functions and details of which are known in the art of transceiver design. Similarly, communication data associated with a second uplink component carrier may be processed for transmission through a corresponding second transmit chain 408. The second transmit chain 408 may include functional components of the base-band modem processor(s) (BB2) and RF front end components of the RF resource, including a DAC 410 and other RF front end components discussed for the first transmit chain 402. In some aspects, various RF front end components may be shared between the first transmit chain 402 and the second transmit chain 408.

In the configuration 400, functions of the baseband modem processor(s) associated with the first uplink carrier and second uplink carrier may be implemented by digital BB1/modulator 412 and digital BB2/modulator 413, respectively. In particular, the digital BB1/modulator 412 may generate a modulated RF signal with the communication data for transmission associated with the first uplink carrier. The digital BB1/modulator 412 may employ any of a number of modulation schemes (e.g., quadrature, polar, etc.) that encode the data for transmission by varying properties of an RF carrier waveform. For example, the digital BB1/modulator 412 may be configured to use quadrature amplitude modulation (QAM), in which in-phase (I) and quadrature (Q) signals based on the information baseband signal are represented as variations in the amplitude, frequency and/or phase of a waveform.

The modulated RF signal with the communication data for transmission may be input into the DAC 404, which converts the modulated RF signal into an analog format RFin signal. Other components may be provided in the first transmit chain 402 to perform functions including, but not limited to, mixers for upconverting the I and Q signals to radio frequencies, a signal combiner for combining the upconverted I and Q signals, filters that filter frequency content of signals, etc.

In various aspects, the PA 406 may be configured to amplify the analog format RFin signal received from the DAC 404 to generate the RFout signal at a desired output power level. The RFout signal in various aspects may subsequently be provided to one or more antennas for transmission over the radio interface to a network through a base station.

In some aspects, the configuration 400 may include a power supply, such as a battery 414, which may provide battery voltage information (Vbatt) for use in adjusting voltage at the PA 406. The configuration 400 may also include a mode switch 416 to allow the wireless communication device to switch operating modes by switching between sources of the PA supply voltage. A switched mode power supply (SMPS) 418 may receive the Vbatt and generate a PA supply voltage (Vcc) for the PA 406 operating in the second power-saving mode (e.g., APT or EPT).

In various aspects, the DAC 410 may be configured to process an RF transmit signal as part of the second transmit chain 408 (e.g., from the digital BB2/modulator 413) or opportunistically to process an envelope signal associated with the first transmit chain 402 (e.g., the envelope of an RF transmit signal from the digital BB1/modulator 412). In the latter use, an ET power supply module 420 may generate an envelope signal based on information derived from the digital BB1/modulator 412, such as the I and Q baseband signals. In various aspects, the envelope signal may be a differential signal tracking the amplitude peaks of the RF input signal. For example, the envelope signal may be computed using the following calculation: Envelope=\sqrt{I²+Q²}.

In various aspects, the ET power supply module 420 may use the envelope signal to generate a PA supply voltage for the PA 406. The ET power supply module 420 may also include and/or be associated with any of a number of components or provide functions relating to processing the envelope signal. For example, the ET power supply module 420 may include an amplitude detector in an envelope shaping block to adjust the envelope signal to improve linearity of the PA.

The configuration 400 may further contain elements that interact in a wireless communication device to provide the discontinuous transmission (DTX) capability according to various aspects. While shown with respect to a call using the second transmit chain 408, the wireless communication device may also be configured with similar elements enabling DTX mode associated with calls using the first transmit chain 402. In various aspects, a microphone 424 may convert an acoustic sound into an electric signal, which may in turn be provided to a voice (e.g., speech) encoder 426. In various aspects, the voice encoder 426 may be part of the one or more CODECs. The voice encoder 426 may encode speech to a lower rate, producing speech frames that may be transferred to a transmit-DTX (TX-DTX) processor 428 and forwarded to the second transmit chain 408.

In a multi-SIM scenario, during an active voice call on the second transmit chain 408, when the associated modem stack is operating in normal mode, the TX-DTX processor 428 may forward the encoded speech frames to the second transmit chain 408, regardless of whether the signal produced by the microphone 424 contains actual speech or mere background noise. Using an antenna, the second transmit chain 408 may send the speech frames as an uplink signal over the radio interface to a network through a base station.

In various aspects, a command received from the network (e.g., a base station of the network) may trigger operation of the PA 406 in DTX mode. During an active voice call on the second transmit chain 408, when the associated modem stack is operating in DTX mode, a voice activity detector (VAD) 430 may analyze the signal produced by the microphone 424 to determine whether the signal contains speech or only background noise.

Aspects of the present disclosure are directed to a mechanism where power tracking (e.g., envelope tracking) is always enabled and can co-exist with an active second connection. Additionally, the aspects are not limited to any specific multi-SIM scenario and are applicable to, for example, all X+X multi-SIM use cases, LTE uplink carrier aggregation scenarios as well as single-SIM designs with LTE-Advanced support.

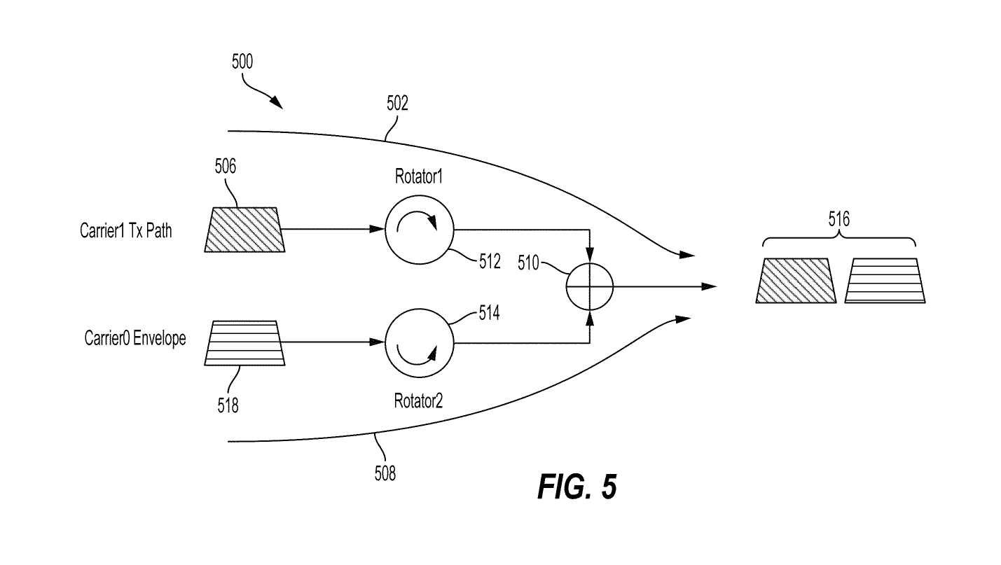

FIG. 5 is an illustration of digital sample rotator mechanism 500 to achieve placement of a transmit path signal and an envelope signal adjacent to each other according to aspects of the present disclosure. Digital samples of the transmit path signal and the envelope signal can be placed adjacent to each other in a frequency domain using a first digital sample rotator 512 (e.g., a phase rotator) and/or a second digital sample rotator 514. The digital sample rotator mechanism 500 includes a first transmit path 502 (e.g., chain 1 or transmit path of carrier 1) and a second path 508 (e.g., chain 0 or an envelope path), and a combiner 510. The first transmit path 502 and the second path 508 denote an active first and second connection, respectively.

The first transmit path 502 may be a default signal path and may additionally include a modem, a transceiver, a PA, a front-end device, and an antenna. The second path 508 may be an envelope signal path from the modem to a power tracking mode device (e.g., switched mode power supply (SNIPS) switcher or envelope tracking power supply), which drives the PA in the power tracking mode (e.g., envelope tracking mode).

Aspects of the present disclosure are directed to the digital sample rotator mechanism 500 where digital-to-analog converter (DAC) sharing is enabled (e.g., always enabled) for an envelope path of carrier 0 and a transmit path of carrier 1. For example, the proposed mechanism implements envelope tracking using a shared DAC approach implementing IQ (in-phase quadrature-phase) sample rotation in digital domain with minimal hardware changes. The transmit path of carrier 1 may include a digital sample 506 of the first transmit path 502 and the first digital sample rotator 512. The envelope path of carrier 0 may include the digital sample 518 of the second transmit path 508 and the second digital sample rotator 514.

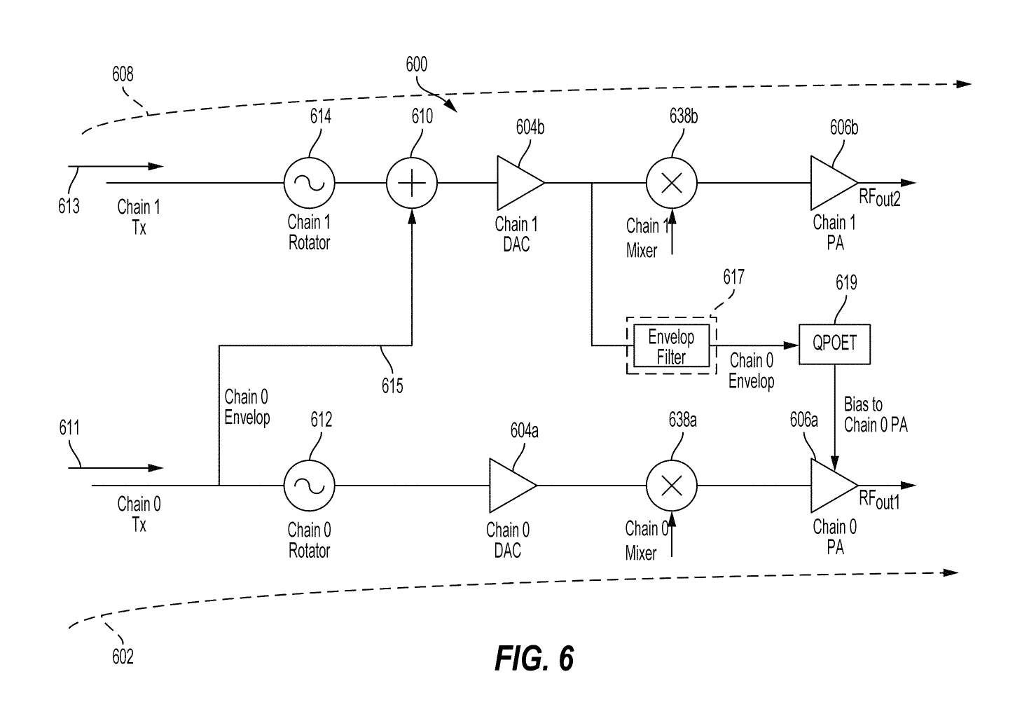

In digital domain, the digital sample 506 through the first transmit path 502 is combined to the digital sample 518 through the second transmit path 508 using digital sample rotation. For example, the combined signals can be placed adjacent to each other without adversely interfering with each other because of the phase rotation of the digital sample 506 and/or the digital sample 518. For example, a phase of the digital sample 506 and/or the digital sample 518 are adjusted by the second digital sample rotator 514 and/or the first digital sample rotator 512 to place the signals adjacent to each other without adversely interfering with each other. Combined digital samples 516 are routed through a same DAC, as illustrated in FIG. 6.

FIG. 6 illustrates digital to analog converter (DAC) sharing mechanism 600 according to aspects of the present disclosure. The DAC sharing mechanism 600 includes a first transmit path 602 and a second transmit path 608. The first transmit path 602 includes a first digital sample rotator 612, a first DAC 604a, a first mixer 638a, a first PA 606a and a first RF output, RFₒᵤₜ₁. The second transmit path 608 includes a second digital sample rotator 614, a combiner 610, a second DAC 604b, a second mixer 638b, a second PA 606b and a second radio frequency output, RFₒᵤₜ₂.

Envelope tracking can be enabled simultaneously with the second transmit path 608 using the DAC sharing mechanism 600 with the assistance of digital sample rotation. The digital sample rotation may be achieved with the first digital sample rotator 612 and/or the second digital sample rotator 614. For example, a second transmit signal 613 of the second transmit path 608 is combined with an envelope signal 615 of a first transmit signal 611 using the combiner 610. The signals are combined such that the envelope signal 615 is adjacent to the second transmit signal 613 without adversely interfering with each other. This combination may be achieved using the second digital sample rotator 614 to adjust a phase of the second transmit signal 613.

The combined signals (the second transmit signal 613 and the envelope signal 615) may then be routed to a same shared power tracking mode DAC (e.g., the second DAC 604b). The envelope signal 615 of the first transmit signal 611 may then be filtered after the second DAC 604b, using an envelope filter 617, from the combined signals and used for power tracking. For example, the envelope signal 615 is filtered out, using the envelope filter 617, from the combined signal and used to drive a power tracking mode device 619. An output of the power tracking mode device 619 may bias the first PA 606a of the first transmit path 602. The first transmit signal 611 continues on the default signal path (e.g., first transmit path 602). A local oscillator (LO) frequency of the second transmit path 608 may be a modified by a same amount as a rotation by the phase rotators (and in opposite direction).

For example, an envelope signal of chain zero (0) (or first transmit path 602) is mixed with a transmit signal of chain one (1) (or second transmit path 608). The chain 1 transmit signal is rotated in digital domain in one direction to accommodate mixing with the incoming envelope signal. Accordingly, to send the chain 1 transmit signal on the intended frequency, the LO frequency for chain 1 is rotated by the same amount in reverse direction.

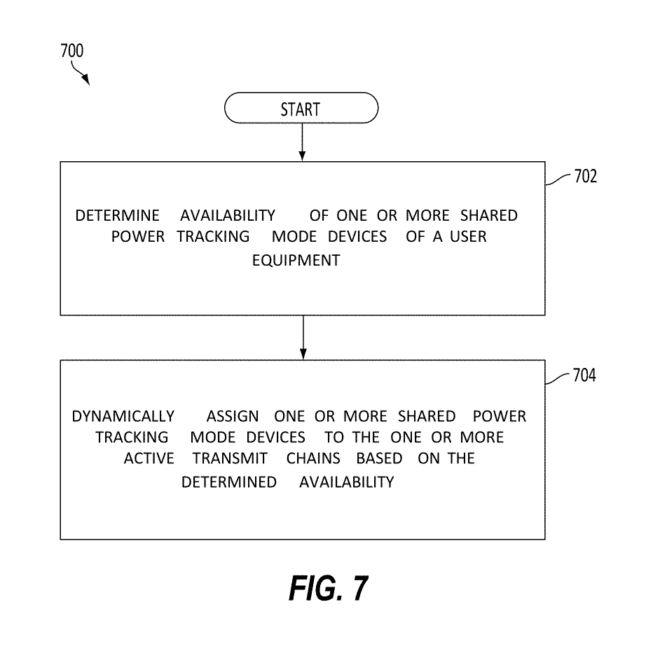

FIG. 7 is a process flow diagram illustrating a method 700 of assigning shared resources to one or more active transmit chains of a user equipment (UE) according to an aspect of the present disclosure. For example, the inputs used by the UE to achieve this process include a number of active transmit paths and available envelope tracking DACs/power tracking mode devices (hardware). The process flow may be implemented in situations where the UE has fewer shared resources than active transmit chains. In block 702, the user equipment determines availability of one or more shared power tracking mode devices of the user equipment. In block 704, the user equipment dynamically assigns one or more shared power tracking mode devices to the one or more active transmit chains based on the availability determination.

In one configuration, an apparatus within a UE is configured for wireless communication including means for determining availability of one or more shared power tracking mode devices of the UE, means for selectively assigning the one or more shared power tracking mode devices to one or more active transmit chains based on the determined availability, and means for determining a power tracking mode to be allocated to the one or more active transmit chains based on one or more previously stored parameters of the one or more active transmit chains. In one aspect, the determining means and the assigning means may be the modem 305, the digital BB1/modulator 412, the digital BB2/modulator 413, the data processor 110, memory 112, a main processor of the UE and/or an application specific processor within the UE. In another aspect, the aforementioned means may be any module or any apparatus or material configured to perform the functions recited by the aforementioned means.

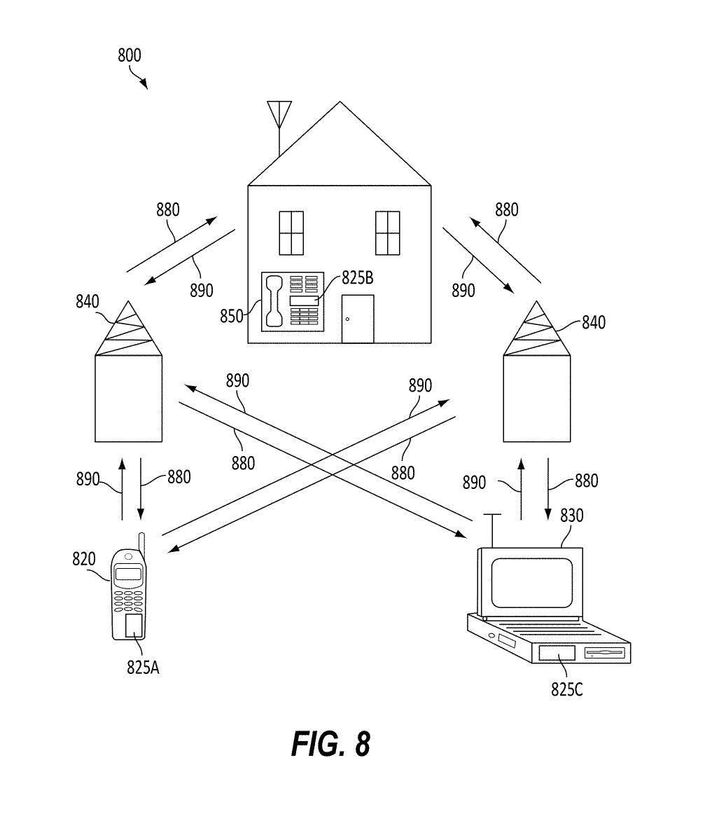

FIG. 8 is a block diagram showing an exemplary wireless communication system 800 in which the dynamic power tracking may be advantageously employed. For purposes of illustration, FIG. 8 shows three remote units 820, 830, and 850 and two base stations 840. It will be recognized that wireless communication systems may have many more remote units and base stations. Remote units 820, 830, and 850 include IC devices 825A, 825C, and 825B that include the disclosed power tracking implementation. It will be recognized that other devices may also include the disclosed power tracking implementation, such as the base stations, switching devices, and network equipment. FIG. 8 shows forward link signals 880 from the base station 840 to the remote units 820, 830, and 850 and reverse link signals 890 from the remote units 820, 830, and 850 to base station 840.

In FIG. 8, remote unit 820 is shown as a mobile telephone, remote unit 830 is shown as a portable computer, and remote unit 850 is shown as a fixed location remote unit in a wireless local loop system. For example, a remote units may be a mobile phone, a hand-held personal communication systems (PCS) unit, a portable data unit such as a personal digital assistant (PDA), a GPS enabled device, a navigation device, a set top box, a music player, a video player, an entertainment unit, a fixed location data unit such as a meter reading equipment, or other communications device that stores or retrieve data or computer instructions, or combinations thereof. Although FIG. 5 illustrates remote units according to the aspects of the disclosure, the disclosure is not limited to these exemplary illustrated units. Aspects of the disclosure may be suitably employed in many devices, which include the disclosed power tracking implementation.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A method of assigning shared resources to at least one active transmit chain of a user equipment (UE), the user equipment having fewer shared power tracking mode devices than active transmit chains, the method comprising:
determining availability of at least one shared power tracking mode device of the user equipment; and
selectively assigning the at least one shared power tracking mode device to the at least one active transmit chain based at least in part on the determined availability.

2. The method of claim 1, further comprising determining a power tracking mode to be allocated to the at least one active transmit chain based at least in part on at least one previously stored parameter of the at least one active transmit chain.

3. The method of claim 2, in which the at least one previously stored parameter comprises a cumulative current consumption of the at least one active transmit chain, current consumption for the power tracking mode, a frequency band of operation for the at least one active transmit chain and/or a peak to average power of a signal to be transmitted by the at least one active transmit chain.

4. The method of claim 2, in which the power tracking mode comprises one of an envelope tracking mode, an enhanced power tracking mode, an average power tracking mode, or a bypass mode.

5. The method of claim 1, in which the shared power tracking mode devices comprise envelope tracking circuitry.

6. The method of claim 1, in which a first of the active transmit chains is assigned to a first uplink component carrier in a carrier aggregation system, and a second of the active transmit chains is assigned to a second uplink component carrier in the carrier aggregation system.

7. The method of claim 1, in which the active transmit chains comprise power amplifiers, and the method further comprises biasing a power amplifier based at least in part on a power tracking mode allocated to the at least one active transmit chain.

8. The method of claim 1, further comprising:
combining a first transmit signal of a first active transmit chain of the active transmit chains to an envelope of a second transmit signal of a second active transmit chain of the active transmit chains using a digital sample rotation to form a combined signal; and
routing the combined signal through a same digital to analog converter.

9. The method of claim 8, further comprising:
filtering out the envelope of the second transmit signal from the combined signal after digital to analog conversion.

10. An apparatus for assigning shared resources to at least one active transmit chain of a user equipment (UE), the user equipment having fewer shared power tracking mode devices than active transmit chains, comprising:
a memory; and
at least one processor coupled to the memory, the at least one processor configured:
to determine availability of at least one shared power tracking mode device of the user equipment; and
to selectively assign the at least one shared power tracking mode device to the at least one active transmit chain based at least in part on the determined availability.

11. The apparatus of claim 10, in which the at least one processor is further configured to determine a power tracking mode to be allocated to the at least one active transmit chain based at least in part on at least one previously stored parameter of the at least one active transmit chain.

12. The apparatus of claim 11, in which the at least one previously stored parameter comprises a cumulative current consumption of the at least one active transmit chain, current consumption per the power tracking mode, a frequency band of operation for the at least one active transmit chain and/or a peak to average power of a signal to be transmitted by the at least one active transmit chain.

13. The apparatus of claim 11, in which the power tracking mode comprises one of an envelope tracking mode, an enhanced power tracking mode, an average power tracking mode, and a bypass mode.

14. The apparatus of claim 10, in which the shared power tracking mode devices comprise envelope tracking circuitry.

15. The apparatus of claim 10, in which the at least one processor is further configured to assign a first of the active transmit chains to a first uplink component carrier in a carrier aggregation system, and to assign a second of the active transmit chains to a second uplink component carrier in the carrier aggregation system.

16. The apparatus of claim 10, in which each of the active transmit chains comprise at least one power amplifier, and in which the at least one processor is further configured to bias the at least one power amplifier based at least in part on a power tracking mode allocated to the active transmit chains.

17. The apparatus of claim 10, in which the at least one processor is further configured:
to combine a first transmit signal of a first active transmit chain of the active transmit chains to an envelope of a second transmit signal of a second active transmit chain of the active transmit chains using a digital sample rotation to form a combined signal; and
to route the combined signal through a same digital to analog converter.

18. The apparatus of claim 17, in which the at least one processor is further configured to filter out the envelope of the second transmit signal from the combined signal after digital to analog conversion.

19. An apparatus for assigning shared resources to at least one active transmit chain of a user equipment (UE), the user equipment having fewer shared power tracking mode devices than active transmit chains, comprising:
means for determining availability of at least one shared power tracking mode device of the user equipment; and
means for selectively assigning the at least one shared power tracking mode device to the at least one active transmit chain based at least in part on the determined availability.

20. The apparatus of claim 19, further comprising means for determining a power tracking mode to be allocated to the at least one active transmit chain based at least in part on at least one previously stored parameter of the at least one active transmit chain.
